(19) United States
(12) Patent Application Publication
(10) Pub. No.: US 2024/0294558 A1
(43) Pub. Date: Sep. 5, 2024

(54) RECOVERY OF SILOXANE CYCLES

(71) Applicant: Evonik Operations GmbH, Essen (DE)

(72) Inventors: Wilfried KNOTT, Essen (DE); Horst DUDZIK, Essen (DE); Frauke HENNING, Essen (DE)

(21) Appl. No.: 18/588,296

(22) Filed: Feb. 27, 2024

(30) Foreign Application Priority Data
Mar. 2, 2023 (EP) 23159727.9

(51) Int. Cl. C07F 7/21

(52) U.S. Cl. CPC C07F 7/21

(57) ABSTRACT

The present invention provides a process for depolymerizing waste silicones to afford siloxane cycles, wherein the process comprises a first step of reacting the waste silicone with at least one alcohol and at least one alkali metal alkoxide without removing any potentially occurring water from the reaction mixture, subsequently neutralizing the reaction mixture, removing the solid constituents and then distillatively removing the optionally previously added solvent and excess alcohol and subsequently heating the obtained alkoxysiloxane with at least one fatty alcohol and at least one alkali metal alkoxide with mixing and distillatively removing the siloxane cycles formed.

### CROSS REFERENCE TO RELATED APPLICATIONS

The present application claims priority under 35 USC § 119 to European application EP 23159727.9, filed on Mar. 2, 2023, the content of which is incorporated herein by reference in its entirety.

### FIELD OF THE INVENTION

The invention is in the field of silicones and the recycling of silicones. The invention especially relates to a process for recovering siloxane cycles from waste silicones.

### BACKGROUND OF THE INVENTION

In line with the concept of sustainability the importance of utilization/re-utilization of waste products from economic cycles is ever increasing. This also applies to the utilization of silicone wastes which in the context of the present invention are also referred to as “end-of-life” silicones. There is therefore a desire to make progress also in this field. Irrespective of this there is on the other hand an increasing need and thus constant demand for organically functionalized siloxanes for applications in the fields of, for example, construction, electricals and electronics, automotive, healthcare and cosmetics as well as numerous other fields of application. Siloxane cycles are of considerable importance as starting materials for the production of a multiplicity of organically functionalized siloxanes.

Siloxane cycles are obtainable for example as downstream products of industrial Müller-Rochow synthesis, the high-temperature nature of which, however, entails a considerable energy demand.

In the context of the present invention siloxane cycles are to be understood as meaning monocyclic, ring-shaped siloxane oligomers consisting of D units (=dimethylsiloxy units) directly bonded to one another, in particular D₃ (hexamethylcyclotrisiloxane), D₄ (octamethylcyclotetrasiloxane), D₅ (decamethylcyclopentasiloxane) and/or D₆ (dodecamethamethylcylohexasiloxane), wherein D₄ (octamethylcyclotetrasiloxane) and/or D₅ (decamethylcyclopentasiloxane) are the siloxane cycles most preferred in the context of the present invention.

Cited as a reference in relation to the M, D, T, Q nomenclature used in the context of this document to describe the structural units of organopolysiloxanes is W. Noll, Chemie und Technologie der Silicone, Verlag Chemie GmbH, Weinheim (1960), page 2 ff.

In a review article, Rupasinghe and Furgal have tried to summarize all available research papers concerning the degradation and depolymerization of polysiloxanes (Polymer international, 71(5), 521-531).

The recycling of silicone rubber wastes poses a particular challenge since this always requires that the fillers incorporated in the silicone rubber be separated from the silicone matrix. This separation task is impeded by the strong interactions between the filler particles and the polydimethylsiloxane chains.

Thus, in connection with the recovery of monomers and fillers from high-temperature crosslinked silicone rubber (HTV) through the combined action of solvents, base and fillers, W. Huang et al. (Polymer 43, 7295-7300 (2002)) discuss the difficulty of finding an effective solvent which also promotes depolymerization of the silicone matrix. It is accordingly not easy to withdraw siloxane cycles from an equilibrated depolymerization mixture to leave behind solvent and fillers. If the solvent is withdrawn before separation of the fillers the remaining siloxane cannot be easily depolymerized, thus necessarily resulting in low yields of siloxane cycles.

The difficulty of depolymerizing the siloxane to be recycled after removing the solvent previously employed for siloxane swelling is apparent for example from DE 19502393 A1 which specifies in example 1 the distillative removal of solvent from an addition-crosslinked polydimethylsiloxane rubber vulcanizate after swelling thereof under reflux conditions in a mixture consisting of hexane, dichloromethane and PNCl₂ and the pyrolysis of the residual gel for one hour at 650° C. to obtain a mixture of cyclic siloxanes as the pyrolysis product.

Huang et al. (loc. cit.) report that a mixture of diethylamine, methanol and hexane is very effective both in inducing the KOH-catalysed depolymerization of an HTV silicone rubber filled with SiO₂ and Al₂O₃ and in removing said fillers completely prior to withdrawal of the siloxane cycles and the solvents.

The authors describe the difficult handling of this complex solvent mixture with reference to the experimental finding that a specific sequence of use of the solvents must be observed to perform a successful depolymerization. Heating the HTV silicone rubber in methanol with addition of potassium hydroxide followed by addition of diethylamine causes the rubber to dissolve after a short time but forms an emulsion and not a dispersion. By contrast, only reflux boiling of the silicone rubber in diethylamine with addition of potassium hydroxide followed by addition of methanol is successful, this rapidly forming a suspension of the filler particles in the liquefied siloxane.

The authors are also confronted with the fundamental need to remove the filler particles from the formed suspension by filtration. Without removal of said solids fractions, a vacuum distillation yields only 7 percent of distillable siloxanes based on the employed silicone rubber compared to 32.1 percent after removal of the solids fractions.

Wedded to the objective of completely separating the filler particles from the siloxane matrix, Huang et al. then also add methanol to achieve aggregation of the finely dispersed polar filler particles and facilitate their removal by filtration.

A person skilled in the art is aware without further explanation that this complicated method with its multiple influencing parameters is not suitable for successful entry into industrial practice.

Ikeda et al. (Green Chemistry, 2003, 5, 508-511) follow up on the results of Huang et al. and substitute tetramethylammonium hydroxide for potassium hydroxide in the complex solvent system consisting of hexane, diethylamine and methanol with the intention of being able to re-use the filler fractions (silicon dioxide and aluminium oxide) re-isolated from the depolymerization of silicone rubber, since it was further apparent from the work of Huang et al. that potassium hydroxide covers the surface of the solids particles, thus reducing the heat stability of fresh silicone rubber formulations filled therewith and thus prohibiting direct reuse thereof.

Oku et al. (Polymer 43, 7289-7293 (2002)) likewise focus on the depolymerization of the radically crosslinked silicone rubber filled with SiO₂ and Al₂O₃ used previously in the investigations of Huang and Ikeda to afford siloxane cycles, wherein potassium hydroxide in toluene and also potassium hydroxide combined with buffer acids without solvent are employed. Good cyclic yields of up to 84% are achieved in particular through stoichiometric combination of KOH with certain buffer acids such as potassium dihydrogenphosphate KH₂PO₄ and the monopotassium salt of terephthalic acid p-KOOC(C₆H₄) COOH, wherein the buffer acids are added only after dissolution of the silicone rubber and before distillative removal of the siloxane cycles.

Taking into account the ideal laboratory conditions underlying the Oku paper it is easy to see how real silicone wastes comprising a wide range of fillers quite different to the acidic and neutral fillers SiO₂ and Al₂O₃ investigated therein, i.e. in particular comprising basic fillers such as for example basic oxides or carbonates and also comprising different content fractions, in practice impede or generally render impossible stoichiometric adjustment of the proposed buffer mixtures.

In Zh. Obshch. Khim. 1959, 29, 1528-1534 (Russian Journal of General Chemistry 1959, 29, 1528-1534) Vornokov and Shabarova describe the production of organoalkoxysilanes by cleavage of organosiloxanes with C₄ to C₁₂ alcohols under basic conditions, wherein alkali metal hydroxides, alkali metal alkoxides or the alkali metals themselves are employed. The authors stress the need to remove water from the reaction system using water-insoluble but azeotrope-forming solvents or yet more preferably through the use of further dehydrating agents. Vornokov produces organoalkoxysilanes from linear, branched or cyclic organosiloxanes by reaction with primary or secondary alcohols having boiling points above 100° C. in the presence of 1 to 10 mol percent of a hydroxide or alkoxide under the conditions of a continuous azeotropic distillation in which inert solvents immiscible with water such as toluene or benzene are employed. The continuous azeotropic distillation is used to remove water using a water separator.

However, Vornokov is not able to convert alcohols such as methanol and especially ethanol having boiling points below 90° C. in this way. To this end, they employ dehydrating agents such as preferably the corresponding tetraalkoxysilanes (tetramethoxysilane and tetraethoxysilane) which according to Vornokov react with the water to form silicon dioxide and the corresponding alcohol.

By contrast, the publication does not provide a solution for the production of alkoxysiloxanes since, as is understood by those skilled in the art, especially any remaining high-boiling tetraalkoxysilanes (for example tetraethoxysilane b.p. 168° C.) and the condensation products resulting therefrom would entail considerable separation and purification effort.

Chang et al. (J. Polym. Res. 2005, 12, 433-438) report the nucleophilic cleavage of crosslinked polysiloxanes to obtain cyclic siloxane monomers which comprised initially swelling a crosslinked, filled polydimethylsiloxane with either 4 or 5 volumes of tetrahydrofuran, toluene or diethylamine at room temperature overnight and subsequently treating the thus-swollen samples with separately prepared, homogeneous solutions of potassium hydroxide in dimethylamine and dissolving them with stirring at room temperature. The authors observed complete dissolution of the silicone rubber constituents over periods of 0.4 to 4 hours. The yields of cyclic products determined after 25 hours of reaction time were in the range from 10% by weight to 77% by weight, wherein the yield of the dissolution experiment performed in diethylamine exceeded the yields determined in the tetrahydrofuran, tetrahydrofuran/toluene and toluene solvent systems.

### Vu et al. (ChemRxiv (2023) 1-8, 2023, CODEN: CHEMWF; ISSN: 2573-2293

URL: https://chemrxiv.org/engage/chemrxiv/public-dashboard) describe the recycling of silicone wastes to afford cyclic siloxanes, wherein the industrial silicone wastes are low-viscosity, unfilled silicone oils consisting primarily of D units and containing impurities such as Si—H, H₂O, HCl and AlCl₃ among others. Adopted depolymerization reagents include the multi-dentate ligand potassium silanolate complexes, preferably employed among which are an 18-crown-6 crown ether potassium silanolate complex and an end-methylated polyethylene glycol-potassium silanolate complex in which the polyether has an average molar mass of 500 g/mol. Since over the course of the depolymerization undertaken under the conditions of vacuum distillation between 150° C. and 170° C. and 5 mbar pressure the viscosity of the reaction matrix increases to such an extent that it makes stirring of the reaction mixture impossible, the authors add 10% by weight of octadecanol. It is speculated that the fatty alcohol addition effectively counters the formation of siloxane structures linked via T-units which can arise from the dehydrogenative condensation between SiH and SiOH groups through dehydrogenative reaction of n-octadecanol itself with the existing SiH groups.

### BRIEF DESCRIPTION OF THE INVENTION

As interesting as all the foregoing findings are, they do not provide a solution to the problem of depolymerizing any desired waste silicones, especially including filled end-of-life silicone rubbers and preferably also systems filled with basic fillers, in an economical and resource-saving manner to afford siloxane cycles. Especially the use of amine bases in the depolymerization step proves a technical challenge since it is necessary to avoid entrainment into the siloxane cycles even in the smallest amounts. A very wide variety of silicone intermediates and end products is obtained by acid-catalysed equilibration which, since it is optimized for minimum acid usage, is highly sensitive even to small concentrations of bases. The methodology described by Vu et al. should also be considered from this aspect. To avoid the crown ether considered very effective but hazardous by the authors they employ as a substitute an end-methylated polyethylene glycol having an average molar mass of 500 g/mol, i.e., represented in the low molecular weight range of this polyether are constituents of ethoxylates which, together with the siloxane cycles, are volatile under the harsh conditions of the vacuum distillation described therein. However, polyethers and low molecular weight ethoxylates disturb the industrially important, acid-catalysed equilibration similarly to amine bases. The authors therefore use only base-catalysed (especially KOSiMe₃-catalysed) equilibration as experimental evidence of re-polymerizability of the recovered siloxane cycles.

Against this backdrop the technical problem addressed by the present invention is accordingly that of finding a novel process which makes it possible to recover siloxane cycles in the purest possible form on a production scale from any desired range of waste silicones, be they silicone oils for example or, much more challengingly, also filled, high-temperature-crosslinked silicone rubbers, while avoiding the use of complex solvent systems and extreme reaction temperatures, such as are described for example in DE 19502393 A1.

### DETAILED DESCRIPTION OF THE INVENTION

The teaching of the as yet unpublished EP patent application having the filing number 22190105.1 relates to a process for producing one or more alkoxysiloxanes by thermal reaction of at least one waste silicone with at least one alkali metal alkoxide and at least one alcohol, wherein the process comprises:
(a) a first step of reacting the at least one waste silicone by mixing with at least one alcohol and at least one alkali metal alkoxide with heating but without removing any potentially occurring water from the reaction mixture and
(b) a second step of neutralizing the reaction mixture resulting from this reaction using at least one Brønsted acid, optionally with addition of at least one solvent, and separating, especially by filtration, the solid constituents and
(c) subsequently isolating the alkoxysiloxane(s) by thermal removal of volatile compounds.

It has now been found that, surprisingly, waste silicones may also be depolymerized to afford siloxane cycles in high yields on the basis of the technical teaching of the aforementioned as yet unpublished EP patent application having filing number 22190105.1 (see also related application US 2024/0052132).

The present invention provides a process for depolymerizing waste silicones to afford siloxane cycles, wherein the process comprises:
(a) a first step of reacting at least one waste silicone by mixing with at least one alcohol and at least one alkali metal alkoxide with heating but without removing any potentially occurring water from the reaction mixture, in particular without the use of inert solvents which are water-insoluble but form azeotropes with water and/or without the use of further dehydrating agents and
(b) subsequently neutralizing the reaction mixture resulting from this reaction in a second step using at least one Brønsted acid optionally with addition of at least one solvent, removing, especially filtratively removing, the solid constituents and then distillatively removing the optionally previously added solvent and the excess alcohol deriving from step (a) from the obtained alkoxysiloxane(s) and
(c) subsequently in a third step heating the thus-obtained alkoxysiloxane(s) with at least one fatty alcohol and at least one alkali metal alkoxide with mixing and, preferably with application of an auxiliary vacuum, thermally removing, preferably distillatively removing, the siloxane cycles formed.

“Inert solvents” in the first step (a) is to be understood as meaning all solvents that exhibit chemically inert behaviour in the first step (a), i.e. do not participate in the reaction itself. Examples of inert solvents which are water-insoluble but form azeotropes with water are accordingly benzene and toluene.

“With heating” in the first step (a) according to the invention is to be understood as meaning the specific heating of the reaction mixture consisting of at least one waste silicone with at least one alcohol and at least one alkali metal alkoxide. The heating may be achieved in known fashion. The heating may preferably be effected via the mantle surfaces of an employed reaction vessel or reactor and optionally using a suitable heat transfer medium, such as for example hot steam, water or oil or also via electric heating for example. When using vigorously stirring machines it is for example also possible according to the invention to utilize the autogenous heating arising in the more or less viscous reaction mixture from the mechanical work done by the machine (friction heat). With reference to the principle configuration possibilities for heating reference is made to Wilhelm R. A. Vauck/Hermann A. Müller, Grundoperationen chemischer Verfahrenstechnik, 8th edition, Weinheim, New York, VCH Verlagsgesellschaft mbH, 1990, pages 421-471.

In the context of the present invention auxiliary vacuum is to be understood as meaning preferably a pressure range smaller than 300 hPa, in particular a pressure range from 0.001 hPa to 250 hPa.

The first step (a) according to the invention provides for reacting at least one waste silicone by mixing with at least one alcohol and at least one alkali metal alkoxide with heating but without removing any potentially occurring water from the reaction, in particular without the use of inert solvents which are water-insoluble but form azeotropes with water and/or without the use of further dehydrating agents.

Especially depending on the dryness of the employed alcohol, which may range for example from technical quality through to an absolute solvent, and of the strongly hygroscopic alkali metal alkoxides the first step (a) according to the invention can form not only alkoxysiloxanes but optionally also proportions of hydroxy-bearing siloxanes (see inventive example 1 with ethanol). However, their possible presence in addition to the alkoxysiloxane is immaterial to the successful performing of the process according to the invention and in particular to the performing of the steps (b) and (c).

If the reaction in the first step (a) of the process according to the invention is undertaken without the use of water-binding silicic esters, in particular without the use of tetraalkoxysilanes, this corresponds to a particularly preferred embodiment of the invention.

The second step (b) according to the invention provides for neutralizing the reaction mixture resulting from the first step (a) using at least one Brønsted acid optionally with addition of at least one solvent, removing, especially filtratively removing, the solid constituents and then distillatively removing the optionally previously added solvent and the excess alcohol deriving from the first step (a) from the obtained alkoxysiloxane(s).

The third step (c) according to the invention provides for heating the alkoxysiloxane(s) obtained from the second step (b) with at least one fatty alcohol and at least one alkali metal alkoxide with mixing and, in particular with application of an auxiliary vacuum, thermally removing, preferably distillatively removing, the siloxane cycles formed.

In a particularly preferred embodiment of the invention the process according to the invention may be performed semicontinuously in the third step (c) by adding to the distillation bottoms depleting or depleted in alkoxysiloxane and in siloxane cycles and still containing fatty alcohol and alkali metal alkoxide a fresh amount of alkoxysiloxane continuously or portionwise and discontinuously and thus restarting or continuing the formation of siloxane cycles.

The thermal, preferably distillative, removal of the volatile compounds resulting from the third step (c) provides a distillate containing siloxane cycles, preferably a distillate comprising, in particular consisting of, the siloxane cycles octamethylcyclotetrasiloxane (D₄) and decamethylcyclopentasiloxane (D₅).

When using the particularly preferred alcohols methanol and/or ethanol in the first step (a) of the process according to the invention it is preferably further possible in the third step (c) to collect a low boilers fraction containing alkoxy-Si structures which, in addition to entrained proportions of siloxane cycles, is analytically determined to substantially consist of dialkoxydimethylsilane and of dialkoxytetramethyldisiloxane.

In the context of the present invention alkoxy-Si structures are silicon-containing silanes or siloxanes which comprise two alkoxy-Si bonds per molecule and on account of their volatility may be thermally, preferably distillatively, removed from the third step (c) according to the invention.

In the context of the present invention the term “low boiler fraction” is to be understood as meaning matter which on account of its elevated volatility may be recovered by thermal removal prior to the thermal removal of the majority of siloxane cycles in the third step (c). Said fraction preferably comprises, in particular consists of, the alkoxy-Si structures dialkoxydimethylsilane and dialkoxytetramethyldisiloxane in addition to entrained proportions of siloxane cycles.

In the context of the present invention the term “volatile” is to be understood as meaning that these substances rapidly evaporate (volatilize) on account of their low boiling point/high vapour pressure. For example, according to the definition of the World Health Organization (WHO), VOCs (volatile organic compounds) are organic substances having a boiling range of 60° C. to 250° C. Citation from “Flüchtige organische Verbindung”, https//wissenwiki.de.

Purely for elucidating the relative volatilities of the substances preferably involved in the third step (c) of the process according to the invention reference is here made to the boiling points referred to on pages 62, 168 and 180 of W. Noll, Chemie und Technologie der Silicone, Verlag Chemie, Weinheim (1960).

For example, using the ethanol particularly preferred in the first step (a) according to the invention would be expected to give rise to the following situation:
(CH₃)₂Si(OC₂H₅)₂ 114° C. boiling point at 742 torr (equivalent to 989.251 hPa)
C₂H₅O[(CH₃)₂SiO]₂C₂H₅ 161° C. boiling point at 760 torr (equivalent to 1013.249 hPa)
[(CH₃)₂SiO]₃ 134° C. boiling point at 760 torr (equivalent to 1013.249 hPa)
[(CH₃)₂SiO]₄ 175° C. boiling point at 760 torr (equivalent to 1013.249 hPa)
[(CH₃)₂SiO]₅ 210° C. boiling point at 760 torr (equivalent to 1013.249 hPa)
[(CH₃)₂SiO]₆ 245° C. boiling point at 760 torr (equivalent to 1013.249 hPa)

The low boiler fraction containing alkoxy-Si structures which is optionally removable, preferably removed, in the third step (c) may preferably optionally be supplied to the first step (a) that is to be restarted or continued, i.e. the depolymerization. As a source of alkoxy groups, said fraction is capable of optionally replacing proportions of the fresh alcohol that is otherwise to be added. This corresponds to a particularly preferred embodiment of the invention.

It thus also corresponds to a particularly preferred embodiment of the invention when excess alcohol deriving from the second step (b) and/or the low boiler fraction containing alkoxy-Si structures optionally removed in the third step (c) are recycled into the depolymerization step (a) as reagents.

Such an approach and an above-described, semicontinuous cyclization process step (c) itself are highly advantageous for a recycling process for waste silicones that is particularly preferred from an aspect of atom economy in the context of a preferred embodiment of the invention.

It corresponds to a preferred embodiment of the invention when the at least one waste silicone is mechanically comminuted prior to reaction, i.e. before performing the first step (a).

The term “waste silicone” (or synonymously: “end-of-life silicones”) encompasses in the context of the teaching of the invention all silicone-based or silicone-containing products and also products with adhering silicone or contaminated with silicone that are close to reaching and/or have already completely reached the end of their respective technical service life or shelf life or would be intended for disposal for any other reason. The shelf life or service life here describes the time for which a material or an article can be used without the replacement of core components or complete failure. In the context of this teaching this also includes silicone adhesives and/or silicone sealants for example in cartridges that are close to reaching the end of their shelf life or their expiry date and/or have exceeded this (assessed according to the degree of hardening to be expected and/or which has already occurred), as well as for example varyingly old sprue and/or stamping waste from silicone rubber production or discarded scrap else electronic containing silicone-sealed components/component assemblies. The term “waste silicone” further comprises in the context of the teaching of the invention all silicone wastes, including production wastes. It comprises in particular all those silicones or silicone-containing components or components with adhering silicone or contaminated with silicone that would otherwise be intended for disposal in the usual manner and are accordingly regarded as waste. It thus also comprises for example silicone adhesive and/or sealant cartridges, in particular used silicone adhesive and/or sealant cartridges, intended for disposal which still have silicone residues adhering or present in and on them. The terms “waste silicones”, “silicone wastes” and “end-of-life silicones” are in the context of the present invention to be understood as being synonymous.

In the context of the present invention waste silicone is especially to be understood as meaning corresponding silicone rubbers and/or silicone oils.

When the at least one waste silicone, in particular corresponding waste silicone oils, are composed of D and M units this represents a further preferred embodiment of the invention.

In the context of the present invention “alkali metal alkoxide” is preferably to be understood as meaning compounds of general formula:

[M⁺][OR⁻],

wherein
M is selected from the group of alkali metals Li, Na or K, preferably Na or K, and
R represents a linear, branched or cyclic alkyl radical, preferably having 1 to 10 carbon atoms, particularly preferably having 1 to 6 carbon atoms, very particularly preferably having 1 or 2 carbon atoms.

According to the invention, at least one alkali metal alkoxide is employed. It is thus possible to employ one or more alkali metal alkoxides. The use of potassium ethoxide, sodium ethoxide, potassium methoxide and/or sodium methoxide is most preferred.

The known processes for producing alkoxides include chloralkali electrolysis by the amalgam process where sodium amalgam is reacted with alcohol [cf. for example Chemical and Engineering News 22, 1903-06 (1944)].

A further known method is the production of alkoxides from an alkali metal and an alcohol or from an alkali metal hydroxide and an alcohol. Alkoxide production from an alkali metal and a tertiary alcohol is known for example from DE-23 33 634 (Dynamit Nobel) or DE 26 12 642 (Degussa). Production of an alkoxide from an alkali metal hydroxide and a tertiary alcohol is likewise known. The first process variant requires the use of costly alkali metal and the second variant proceeding from alkali metal hydroxide requires that the water formed during the reaction be removed by distillation, thus necessitating correspondingly high thermal outlay.

According to the teaching of DE-A-33 46 131 alkali metal alkoxides may be produced from salts by electrolysis, wherein an electrolysis cell where a cation exchange membrane separates the electrode spaces is employed. DE-42 33 191.9-43 describes a process which allows production of an alkali metal alkoxide from a salt by electrodialysis.

Also described individually are processes for producing speciality alkoxides, for example the alkoxides of higher and/or polyhydric alcohols. Alkoxides of higher and/or polyhydric alcohols are known to be producible in principle by transalcoholization, i.e. by substitution of the alkoxide radical of lower alkoxides ROM by reaction with higher alcohols R′OH (wherein R and R′ are alkyl radicals of different carbon chain lengths and M represents a metal cation) in a liquid reaction mixture at suitable temperature and pressure conditions. In the laboratory jargon this reaction substituting the alkoxide radical is referred to as “recooking”. The position of the equilibrium ROM+R′OH⇔ROH+R′OM depends on the acidity of the two alcohols which decreases according to the sequence methanol>primary>secondary>tertiary alcohols [R. T. Mclver and J. A. Scott, J. American Chem. Soc. 96 (1973) 2706]. Accordingly, it is said that the production of the alkoxides of secondary alcohols in this way is possible only in exceptional cases and the production of the alkoxides of tertiary alcohols by transalcoholization is entirely unsuccessful [“Methoden der Organischen Chemie” (1963) Vol. 6/2, p. 13]. However, DE-1 254 612 and DE-27 26 491 (both Dynamit Nobel) disclose production of alkoxides by recooking for higher alcohols too. GB-1 143 897 (Metallgesellschaft) describes the reaction of a monovalent alkali metal alkoxide with a C₂ to C₁₈ alcohol or phenol containing up to six hydroxyl groups, wherein an excess of monohdyric alcohol and/or a hydrocarbon is employed as solvent. However, the recooking always leads to formation of the low-boiling alcohol ROH (for example methanol) which, for isolation of the desired alkoxide-optionally in addition to the unconverted higher alcohol R′OH-requires removal from the reaction product mixture in some cases with considerable thermal outlay.

Apart from these thermal equilibrium shifts, EP 0776995 B1 also teaches a process for producing alkoxides under the influence of an electric field, wherein an alcohol is converted into the desired alkoxide by supplying metal ions and the metal ions themselves derive from the electrochemical decomposition of another alkoxide in the electric field. The alkoxide formation and decomposition are carried out in chambers spatially separated by ion exchange membranes.

The at least one alkali metal alkoxide employed in the first step (a) of the process according to the invention is preferably employed therein in total amounts of 1% to 20% by mass, preferably 5% to 19% by mass, particularly preferably 6% to 18% by mass, based on the total mass of the waste silicone employed in the reaction. This corresponds to a preferred embodiment of the invention.

It is preferable when the first step (a) of the process according to the invention is performed in the temperature range of 50° C. to 200° C., preferably in the temperature range of 60° C. to 180° C., especially between 78° C. and 170° C., and over a period of preferably 0.5 to 12 hours, preferably over a period of 1 to 8 hours, in each case preferably in the absence of solvent. This corresponds to a particularly preferred embodiment of the invention.

The process according to the invention may in the first step (a) preferably be performed at a pressure above 1013.25 hPa and below 12000 hPa, i.e. at superatmospheric pressure. It may likewise also preferably be performed at standard atmospheric pressure.

In a preferred embodiment of the invention the at least one alcohol employed in the first step (a) in the process according to the invention is selected from the group consisting of linear, branched and cyclic C₁ to C₁₀ alkanols. It is also possible to employ one or more alcohols, i.e. also mixtures of alcohols, preferably methanol, ethanol, 1-propanol, isopropanol, 1-butanol, 2-butanol, isobutanol, pentanols, hexanols, heptanols, octanols, nonanols and/or decanols and/or isomers thereof, particularly preferably methanol and/or ethanol, very particularly preferably ethanol.

In the first step (a) the process according to the invention provides inter alia that the reaction is carried out without removing any potentially occurring water from the reaction mixture, in particular without the use of inert solvents which are water-insoluble but form azeotropes with water and/or without the use of further dehydrating agents.

The alcohol employed in the first step (a) is not considered a solvent in the context of this first step (a). That is to say the at least one alcohol, preferably selected from the group consisting of linear, branched and cyclic C₁ to C₁₀ alkanols, in particular methanol, ethanol, 1-propanol, isopropanol, 1-butanol, 2-butanol, isobutanol, pentanols, hexanols, heptanols, octanols, nonanols and/or decanols, and/or isomers thereof, particularly preferably methanol and/or ethanol, very particularly preferably ethanol, is/are not solvents in the context of the first step (a) of claim 1.

In a preferred embodiment of the invention the at least one alcohol employed in the first step (a) is employed in total amounts of 10% to 200% by mass, preferably 20% to 100% by mass, particularly preferably in amounts of 30% to 80% by mass, based on the total mass of the waste silicone altogether employed in the reaction.

Ensuring good stirrability and miscibility in the first step (a) of the process according to the invention can preferably have a positive effect on the ease with which the dissolution process is carried out. In this regard it may be preferable for avoidance of high shear and stirring powers, especially when using solid waste silicones having a high degree of polymerization and possible crosslinking, to configure the first step a) of the process according to the invention such that it is sequenced for example, i.e. initially reacting a portion of optionally previously comminuted waste silicone with alkali metal alkoxide(s) and alcohol(s) with heating and subsequently evaluating the consistency of the reaction matrix in respect of its stirrability and miscibility. If this reaction matrix proves readily stirrable a further portion of the waste silicone may be added and the process continued in accordance with the invention. This procedure may be continued until the reaction matrix has the desired target rheology. This corresponds to a preferred embodiment of the invention.

In the context of a further preferred embodiment and advantageously for the achievable yield in the reaction of the waste silicone with at least one alcohol and at least one alkali metal alkoxide the reaction according to the invention may also be performed under superatmospheric pressure conditions in a pressure-resistant reactor. The recorded pressure increase is preferably autogenous in nature and is attributable to the vapour pressure of the system components involved therein. If desired the reactor may preferably also be charged with an inert gas cushion.

For the use of the process according to the invention on an industrial scale it may be advisable and thus preferable to initially evaluate the respective waste silicone with the aid of some preliminary laboratory scale reference experiments in order thus to determine the process parameters that are optimal in each case.

As is understood by those skilled in the art the behaviour of the respective waste silicone in the reaction according to the invention will be influenced inter alia by the degree of polymerization, the degree of crosslinking and, if present, the type and quantity of the filler that may be processed in said waste silicone. Among the waste silicones especially peroxidically postcrosslinked and also heat-treated silicone rubbers always present a particular technical challenge for chemical recycling. The heat treatment of silicone rubber components improves their dimensional stability and prevents them from sweating plasticizers, in particular during use in very hot conditions.

According to the invention the reaction mixture resulting from the first step (a) of the process according to the invention is neutralized by addition of at least one Brønsted acid, optionally with addition of at least one solvent, in the context of a second step (b). One or more Brønsted acids may be employed. Anhydrous mineral acids (such as preferably anhydrous sulfuric acid and/or anhydrous perchloric acid) and/or anhydrous organic acids (such as preferably anhydrous acetic acid) may preferably be used for neutralization. Anhydrous sulfuric acid, anhydrous perchloric acid and/or anhydrous acetic acid are especially employed.

When using anhydrous mineral acid(s) the addition amount thereof is preferably chosen such that stoichiometric equivalence based on the altogether employed alkali metal alkoxide is achieved. When using the markedly weaker, anhydrous organic acid(s) (for example anhydrous acetic acid) it is preferable to choose a marked stoichiometric excess of acid based on altogether employed alkali metal alkoxide. This is preferably measured up to 50% stoichiometric excess.

The usage amount of the altogether employed Brønsted acid is thus preferably chosen such that it is in the range from stoichiometric equivalence to a 50% stoichiometric excess, in each case based on altogether employed alkali metal alkoxide.

Especially when the salt quantity foreseeable from the neutralization step according to the invention stands in the way of easy filtration the use of at least one solvent may preferably be provided for. One or more solvents may optionally be employed.

One or more solvents which are suitable according to the invention in the context of the second step (b) are preferably those which are themselves chemically inert with regard to the reaction system and which promote dilution/dispersion of the constituents of the neutralization step. The at least one solvent is preferably selected from the group consisting of alkanes, alkylaromatics, alcohols, hexamethylcyclotrisiloxane (D₃), octamethylcyclotetrasiloxane (D₄), decamethylcyclopentasiloxane (D₅) and dodecamethylcyclohexasiloxane (D₆).

The use of alkylaromatics, such as preferably toluene and/or xylenes, is particularly preferred. Likewise, preferably employable are siloxanes selected from the group consisting of hexamethylcyclotrisiloxane (D₃), octamethylcyclotetrasiloxane (D₄), decamethylcyclopentasiloxane (D₅) and dodecamethylcyclohexasiloxane (D₆) and mixtures thereof.

The solid constituents resulting from the neutralization may then preferably be removed, in particular filtratively removed, in the context of the second step (b). Then, especially after filtrative removal of the solid constituents resulting from the neutralization, the volatile compounds are distillatively removed n the context of the second step (b) and the alkoxysiloxane which may optionally also contain proportions of hydroxy-functional polydimethylsiloxane is isolated.

The third step (c) of the process according to the invention preferably employs at least one fatty alcohol by preference having a carbon number of C₁₂ to C₁₈, preferably having a carbon number of C₁₄ to C₁₈, in particular having a carbon number of C₁₆ (preferably stearyl alcohol=hexadecanol). The use of stearyl alcohol is very particularly preferred. It is likewise particularly preferable to employ mixtures of two or more suitable fatty alcohols.

It is preferable when the at least one fatty alcohol used in the third step (c) is employed in amounts of 20% to 50% by weight, preferably in amounts of 25% to 35% by weight, based on the total amount of alkoxysiloxane present.

It is preferable when the amount of alkali metal alkoxide used in the third step (c) is 10% to 20% by weight, preferably 12% to 18% by weight, based on the total amount of the at least one fatty alcohol used in the third step (c).

It is preferable when the third step (c) of the process according to the invention is performed in the temperature range of 100° C. to 200° C., preferably in the temperature range of 120° C. to 160° C., and over a period of preferably 1 to 12 hours, preferably over a period of 2 to 8 hours, in each case preferably with application of an auxiliary vacuum, preferably at a pressure range below 300 hPa, in particular at a pressure range of 0.001 hPa to 250 hPa. This corresponds to a preferred embodiment of the invention.

The siloxane cycles resulting from the third step (c) according to the invention are suitable, especially in optionally distillatively post-purified form, as starting materials for producing a multiplicity of organomodified siloxanes according to any processing routes familiar to those skilled in the art.

### EXAMPLES

The examples which follow serve merely to elucidate the present invention to those skilled in the art and do not constitute any limitation of the subject matter of the invention whatsoever. ²⁹Si-NMR spectroscopy was used for reaction monitoring in all examples.

In the context of the present invention, the ²⁹Si NMR samples were analysed at a measurement frequency of 79.49 MHz in a Bruker Avance Ill spectrometer equipped with a 287430 sample head with gap width of 10 mm dissolved at 22° C. in CDCl₃ and against a tetramethylsilane (TMS) external standard [d(²⁹Si)=0.0 ppm].

Unless otherwise stated all percentages are to be understood as meaning weight percentages.

### Example 1 (Inventive)

In a 1000 ml four-necked round flask fitted with a KPG stirrer, internal thermometer and reflux cooler 300 g of a mixed silicone rubber waste consisting of 150 g of a small particle size, crosslinked silicone extruder waste (particle diameter about 6 mm) and 150 g of a bathroom and sanitary silicone (Conel GmbH, Manhattan grey) that had previously been cured in air on a polyethylene film and comminuted to a comparable particle size together with 300 g of ethanol and 50 g of sodium ethoxide (NaOC₂H₅) were quickly heated to 80° C. with stirring to establish light reflux boiling.

After a reaction time of about one hour the silicone pieces had dissolved and a homogeneous yellow-brownish suspension had formed. The batch was allowed to cool to 40° C. and with continued staring 66.3 g of anhydrous acetic acid were added (50% acid excess based on employed alkoxide). The mixture was stirred for a further period of about 30 minutes and the solid constituents were filtratively removed using a filter press fitted with a Seitz K300 filter disc.

The obtained filtrate was freed of ethanol at 70° C. and an applied auxiliary vacuum of <5 mbar using a rotary evaporator. The evaporative concentration of the filtrate was accompanied by a slight salt precipitation which was removed by filtration through a pleated filter (MN 606¼).

According to ²⁹Si-NMR spectroscopy the yellowish-brownish filtrate consisted of an α,ω-diethoxypolydimethylsiloxane having an average chain length of N=20.8 with smaller proportions of a hydroxy-functional polydimethylsiloxane.

A 30 g sub-amount of said filtrate together with 15 g of stearyl alcohol (hexadecanol) and 2.5 g of potassium methoxide was heated at standard pressure (1013.25 hPa) on the rotary evaporator at a bottoms temperature of 130° C. for one hour, with no distillate accumulation being observed.

Subsequently, the bottoms temperature was increased to 140° C. and an auxiliary vacuum of <5 mbar was applied. Within the next 2 hours the majority of distillate went over and after altogether 4 hours 18.1 g of a colourless, clear distillate corresponding to 60.3% of the employed alkoxysiloxane amount was isolated, the accompanying GC analysis attributing to said distillate a composition of 0.54% D₃, 83.9% D₄, 11.0% D₅ and 1.8% D₆ at complete freedom from ethanol (<0.01%) (summed to 97.2%) A downstream cold trap additionally collected 3.2 g of a colourless, clear liquid. This low boilers fraction containing alkoxy-Si structures corresponded in its amount to 10.7% of the employed alkoxysiloxane amount and according to the accompanying GC analysis had a composition of 2.4% D₃, 52.0% D₄, 0.29% D₅ and <0.02% D₆ as well as 1.8% ethanol (sum of siloxane cycles=54.7%). According to ²⁹Si-NMR spectroscopy the remaining constituents consisted of diethoxydimethylsilane and diethoxytetramethyldisiloxane.

In the context of the semicontinuous process mode particularly preferred according to the invention the rotary flask of the rotary evaporator was then again charged with a 30 g sub-amount of the filtrate and the previously described procedure was repeated with the exception that a bottoms temperature of 140° C. was selected at the outset.

26.2 g of a colourless, clear distillate (equivalent to 87.3% of the employed alkoxysiloxane amount) were isolated. The accompanying GC analysis attributed to this distillate a composition of 0.6% D₃, 82.5% D₄, 12.1% D₅ and 2.0% D₆ as well as <0.01% ethanol (sum of siloxane cycles 97.2%). The contents of the downstream cold trap likewise consisted of a colourless, clear liquid and weighed 3.0 g (equivalent to 10.0% of the employed alkoxysilane amount). The accompanying GC analysis attributed to the cold trap contents a composition of 6.4% D₃, 82.8% D₄, 1.30% D₅ and 0.04% D₆ as well as 0.14% ethanol (sum of siloxane cycle proportions=90.2%). According to ²⁹Si-NMR spectroscopy the remaining constituents consisted of diethoxydimethylsilane and diethoxytetramethyldisiloxane.

All references cited herein are fully incorporated by reference. Having now fully described the invention, it will be understood by those of skill in the art that the invention may be practiced within a wide and equivalent range of conditions, parameters and the like, without affecting the spirit or scope of the invention or any embodiment thereof.

1-15. (canceled)

16. A process for depolymerizing waste silicones to provide siloxane cycles, wherein the process comprises:
(a) creating a reaction mixture by mixing at least one waste silicone with at least one alcohol and at least one alkali metal alkoxide with heating but without either the use of inert solvents which are water-insoluble but form azeotropes with water and/or without the use of further dehydrating agents;
(b) neutralizing the reaction mixture of step a) using at least one Brønsted acid, removing, any solid constituents present, and then distillatively removing any previously added solvent and excess alcohol present in step (a) from the alkoxysiloxane(s) produced; and
(c) heating the alkoxysiloxane(s) of step b) with at least one fatty alcohol and at least one alkali metal alkoxide by mixing and thermally removing the siloxane cycles formed.

17. The process of claim 16, wherein the reaction in step (a) is undertaken without the use of water-binding silicic esters.

18. The process of claim 16, wherein the at least one alkali metal alkoxide has the general formula [M⁺] [OR⁻], wherein:
M is selected from the group consisting of alkali metals Li, Na and K, and
R represents a linear, branched, or cyclic alkyl radical.

19. The process of claim 18, wherein the at least one alcohol employed in step (a) is a linear, branched, or cyclic C₁ to C₁₀ alkanol, and/or the isomers thereof.

20. The process of claim 18, wherein the at least one alcohol employed in step (a) is selected from the group consisting of: methanol, ethanol, 1-propanol, isopropanol, 1-butanol, 2-butanol, isobutanol, pentanol, hexanol, heptanol, octanol, nonanol and/or decanol and/or the isomers thereof.

21. The process of claim 19, wherein the at least one alcohol employed in step (a) is used in a total amount of 10% to 200% by mass, based on the total mass of the waste silicone in the reaction.

22. The process of claim 19, wherein the at least one alkali metal alkoxide employed in step (a) is used in a total amount of 1% to 20% by mass, based on the total mass of the waste silicone employed in the reaction.

23. The process of claim 19, wherein the at least one Brønsted acid added in step (b) is an anhydrous mineral acid and/or anhydrous organic acid.

24. The process of claim 23, wherein the at least one Brønsted acid added in step (b) is anhydrous sulfuric acid, anhydrous perchloric acid and/or anhydrous acetic acid.

25. The process of claim 16, wherein step (b) comprises a solvent selected from the group consisting of: alkanes, alkylaromatics, alcohols, hexamethylcyclotrisiloxane (D₃), octamethylcyclotetrasiloxane (D₄), decamethylcyclopentasiloxane (D₅) and dodecamethylcyclohexasiloxane (D₆).

26. The process of claim 16, wherein step (a) is carried out at a temperature between 50° C. and 200° C.

27. The process of claim 16, wherein step (a) is performed over a period of 0.5 to 12 hours and at a pressure above 1013.25 hPa and below 12000 hPa.

28. The process of claim 16, wherein, step (c) is performed semicontinuously by adding a fresh amount of alkoxysiloxane continuously or portionwise to a distillation bottoms and discontinuously thereby restarting or continuing the formation of siloxane cycles and/or removing a low boilers fraction containing alkoxy-Si structures and supplying it to step (a).

29. The process of claim 16, wherein step (c) employs at least one fatty alcohol having a carbon number of C₁₂ to C₁₈.

30. The process of claim 16, wherein the at least one fatty alcohol used in step (c) is employed in a total amount of 20% to 50% by weight, based on the total amount of alkoxysiloxane present.

31. The process of claim 16, wherein the amount of alkali metal alkoxide present in step (c) is 10% to 20% by weight, based on the total amount of the at least one fatty alcohol used in step (c).

32. The process of claim 16, wherein step (c) is performed in the temperature range of 100° C. to 200° C. for a period of 1 to 12 hours.

33. The process of claim 20, wherein the at least one Brønsted acid added in step (b) is anhydrous sulfuric acid, anhydrous perchloric acid and/or anhydrous acetic acid.

34. The process of claim 33, wherein step (c) employs at least one fatty alcohol having a carbon number of C₁₂ to C₁₈.

35. The process of claim 34, wherein the amount of alkali metal alkoxide present in step (c) is 10% to 20% by weight, based on the total amount of the at least one fatty alcohol used in step (c).
